(19) United States
(12) Patent Application Publication
(10) Pub. No.: US 2009/0169988 A1
(43) Pub. Date: Jul. 2, 2009

(54) AA and AAA Alkaline dry batteries

(76) Inventors: Fumio KATO, Osaka (JP); Hidekatsu IZUMI, Osaka (JP); Yasushi SUMIHIRO, Hyogo (JP); Yasuhiko BITO, Osaka (JP); Eiji TANO, Osaka (JP)

Correspondence Address: MCDERMOTT WILL & EMERY LLP, 600 13TH STREET, NW, WASHINGTON, DC, 20005-3096, US

(21) Appl. No.: 12/340,136

(22) Filed: Dec. 19, 2008

Related U.S. Application Data
(60) Provisional application No. 61/022,670, filed on Jan. 22, 2008.

(30) Foreign Application Priority Data
Dec. 28, 2007 (JP) 2007-339296
Jan. 11, 2008 (JP) 2008-004697

(51) Int. Cl. H01M 2/08

(52) U.S. Cl. 429/174

(57) ABSTRACT

An AA alkaline dry battery includes a bottomed cylindrical casing of which internal volume is 6.25 ml or larger and which accommodates a positive electrode containing manganese dioxide of 9.30 g or more, a negative electrode containing zinc, and electrolyte containing an aqueous solution of potassium hydroxide of which concentration is 33.5 wt % or lower; a sealing member sealing the casing; and a negative electrode current collector extending from the sealing member into the negative electrode. The dry battery has, as discharge characteristics in the middle rate current discharge (AA dry batter), discharge duration until the battery voltage becomes 0.9 V is 9.3 hours or longer where discharge at 250 mA is performed at 25° C. for one hour per day.

### BACKGROUND OF THE INVENTION

1. Field of the Invention

The present invention relates to AA and AAA alkaline dry batteries.

2. Description of Related Art

Alkaline dry batteries, which have electric capacities lager than manganese dry batteries, exhibit efficient discharge characteristics even in long term use at a large current and are therefore being used widely. In response to a demand for dry batteries having further larger electric capacities, researches and developments have been promoted for increasing the electric capacities.

For example, Japanese Unexamined Patent Application Publication (Translation of PCT Application) No. 2002-523874 discloses a technique for increasing the lifetime of a dry battery by setting the internal volume of its casing up to 88.4% or more of the total volume of the dry battery to increase the total amount of the electric chemical materials.

Further, Japanese Unexamined Patent Application Publication (Translation of PCT Application) No. 8-509095 discloses a technique for increasing the lifetime of a dry battery by setting the zinc density at 1.4 g or more per 1 cm³ volume of a positive electrode and the manganese dioxide density at 2.7 g or more per 1 cm³ volume of a negative electrode.

### SUMMARY OF THE INVENTION

### Problems that the Invention is to Solve

Recent proliferation of portable audio video (AV) tools and electronic game machines increases demand for high discharge performance in use at approximately 50 to 500 mA (especially, around 250 mA in AA alkaline dry batteries and around 100 mA in AAA alkaline dry batteries), namely, in a range of the middle-class current (hereinafter referred to it as a middle-rate current), which requires a technique different from the conventional technique that can achieve a long lifetime at a large current.

The techniques disclosed in the aforementioned publications can increase the battery lifetime (electric capacity) in mainly low rate current discharge and are not aimed at enhancing the discharge performance in the middle rate current more than ever. The discharge characteristics in the middle rate current discharge in these techniques are equivalent to those in the conventional one.

### Means for Solving the Problems

The present invention has been made in view of the foregoing and has its object of providing an AA alkaline dry battery and an AAA alkaline dry battery having excellent discharge characteristics in the middle rate current discharge.

In order to solve the above problem, the present invention provides an AA alkaline dry battery which includes: a bottomed cylindrical casing accommodating a positive electrode containing manganese dioxide, a negative electrode containing zinc, and electrolyte containing an aqueous solution of potassium hydroxide; a sealing member sealing the casing; and a negative electrode current collector extending from the sealing member into the negative electrode, wherein an internal volume of the casing which is defined by the casing, the sealing member, and the negative electrode current collector is 6.25 ml or larger, the manganese dioxide contained in the positive electrode is 9.30 g or more, a concentration of the potassium hydroxide of the electrolyte is 33.5 wt % or lower, and discharge duration until a battery voltage becomes 0.9 V is 9.3 hours or longer where discharge at 250 mA is performed at 25° C. for one hour per day.

Herein, the internal volume of the casing defined by the casing, the sealing member, and the negative electrode current collector is a volume of a sealed space within the case where the bottomed cylindrical casing is covered with the sealing member as a lid and the negative electrode current collector extending from the sealing member into the space inside the casing is placed therein. The amount of the manganese dioxide contained in the positive electrode means the amount of pure manganese dioxide rather than the amount of generally used electrolyte manganese dioxide. The amount of pure manganese dioxide can be obtained by chemical analysis of the contents of a dry battery. The content ratio of pure manganese dioxide contained in electrolyte manganese dioxide is approximately 93 wt % in general. The concentration of potassium hydroxide is a concentration obtained by chemical analysis of the contents of a dry battery.

The casing may have an outer diameter of 13.90 mm or larger.

The casing may have a side face of which thickness is 0.20 mm or smaller.

A sealing thickness, which is a distance between a top face of the negative electrode terminal plate and a lower end of the sealing member may be 4.0 mm or smaller.

The electrolyte contains ZnO of which concentration may be 1.5 weight % or lower. Wherein, the concentration of ZnO is obtained by chemical analysis of the contents of a dry battery.

An AAA alkaline dry battery in accordance with the present invention includes: a bottomed cylindrical casing accommodating a positive electrode containing manganese dioxide, a negative electrode containing zinc, and electrolyte containing an aqueous solution of potassium hydroxide; a sealing member sealing the casing; and a negative electrode current collector extending from the sealing member into the negative electrode, wherein an internal volume of the casing which is defined by the casing, the sealing member, and the negative electrode current collector is 2.86 ml or larger, the manganese dioxide contained in the positive electrode is 4.05 g or more, a concentration of the potassium hydroxide of the electrolyte is in a range between 26.0 and 34.0 wt %, both inclusive, and discharge duration until a battery voltage becomes 0.9 V is 11 hours or longer where discharge at 100 mA is performed at 25° C. for one hour per day.

Herein, the internal volume of the casing defined by the casing, the sealing member, and the negative electrode current collector is a volume of a sealed space within the case where the bottomed cylindrical casing is covered with the sealing member as a lid and the negative electrode current collector extending from the sealing member into the space inside the casing is placed therein. The amount of the manganese dioxide contained in the positive electrode means the amount of pure manganese dioxide rather than the amount of generally used electrolyte manganese dioxide. The amount of pure manganese dioxide can be obtained by chemical analysis of the contents of a dry battery. The content ratio of pure manganese dioxide contained in electrolyte manganese dioxide is approximately 93 wt % in general. The concentration of potassium hydroxide is a concentration obtained by chemical analysis of the contents of a dry battery.

The casing may have a side face of which thickness is 0.20 mm or smaller.

The electrolyte contains ZnO of which concentration may be below 2.0 weight %. Wherein, the concentration of ZnO is obtained by chemical analysis of the contents of a dry battery.

### BRIEF DESCRIPTION OF THE DRAWINGS

FIG. 1 is a partially exploded sectional view of an AA alkaline dry battery in accordance with Embodiment 1.

FIG. 2 is an enlarged sectional view of a sealing part of the AA alkaline dry battery in accordance with Embodiment 1.

FIG. 3A is an enlarged view of components of a sealing unit of the AA alkaline dry battery, and FIG. 3B is a view where the sealing unit is assembled.

FIG. 4 is a partially exploded sectional view of an AAA alkaline dry battery in accordance with Embodiment 2.

FIG. 5 is an enlarged sectional view of a sealing part of the AAA alkaline dry battery in accordance with Embodiment 2.

FIG. 6A is an enlarged view of components of a sealing unit of the AAA alkaline dry battery, and FIG. 6B is a view where the sealing unit is assembled.

FIG. 7 is a table indicating the constructions and the characteristics of commercially available AA alkaline dry batteries.

FIG. 8 is a table indicating the constructions and the characteristics of commercially available AAA alkaline dry batteries.

FIG. 9 is a table indicating evaluation results of AA alkaline dry batteries in accordance with Working Examples 1 and 2.

FIG. 10 is a table indicating evaluation results of AAA alkaline dry battery in Working Example 3.

### BEST MODE FOR CARRYING OUT THE INVENTION

Prior to description of embodiments of the present invention, the course for reaching the present invention which the inventors took will be described.

The lifetime of a battery can be increased generally by packing the materials of the positive electrode and the negative electrode as much as possible into the casing. Since the shapes and the dimensions of dry batteries are set in the EIC standard, Tow methods may be considered for packing the component materials as much as possible: a method of reserving much volume for material packing in the casing; and a method of increasing the packing density of the component materials. Each method disclosed in the aforementioned publications employs these methods as well.

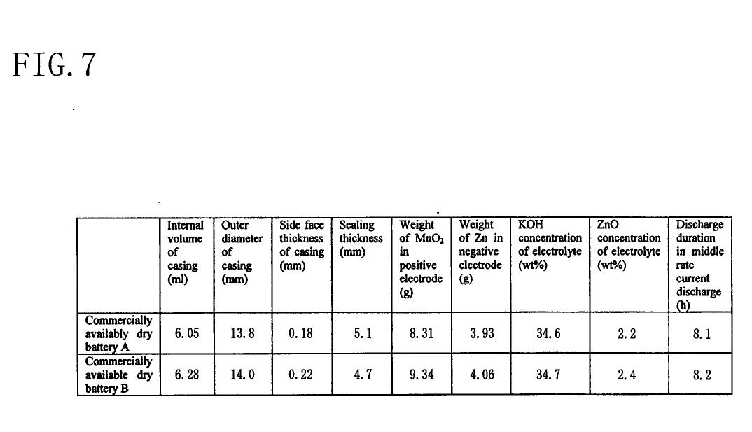

In view of the foregoing, commercially available AA alkaline dry batteries were examined to find that the duration in the middle rate current discharge (AA dry battery) was short, 8.1 hours in a commercially available AA dry battery A in FIG. 7, which has a battery casing of which internal volume is comparatively small and a positive electrode and a negative electrode of which the amounts of materials are less. Wherein, the duration in the middle rate current discharge (AA dry battery) means discharge duration until the battery voltage becomes 0.9 V where the dry battery is allowed to discharge at 250 mA for one hour per day at 20° C.

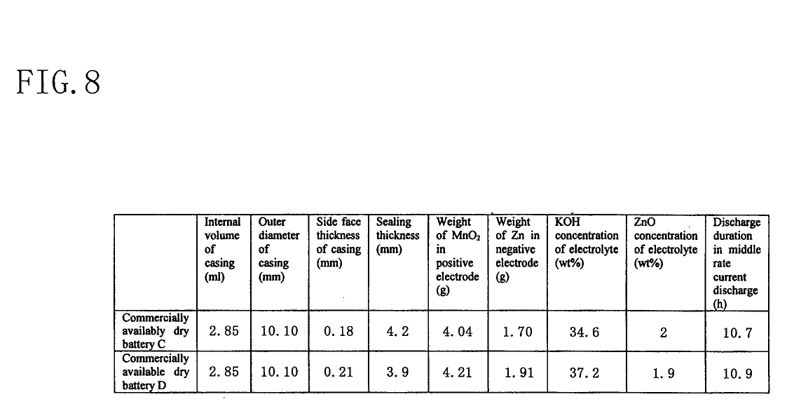

As well, examination on commercially available AAA alkaline dry batteries revealed that the duration in middle rate current discharge (AAA dry battery) is also low, 10.7 hours in a commercially available AAA dry battery C in FIG. 8, which has a positive electrode and a negative electrode of which the amounts of materials are less. Wherein, the duration in the middle rate discharge (AAA dry battery) means discharge duration until the battery voltage becomes 0.9 V where the battery is allowed to discharge at 100 mA for one hour per day at 20° C.

Since a commercially available dry battery B is about 4% larger in the internal volume of the casing than the commercially available dry battery A so that the component materials of a positive electrode and a negative electrode are packed much more, the lifetime of the dry battery B might have been longer than that of the dry battery A. The duration in the middle rate current discharge (AA dry battery) of the dry battery B, however, was almost equal to that of the dry battery A, Therefore, it was found that mere increases in amounts of the component materials of the positive electrode and the negative electrode lead to no increase in discharge duration in the middle rate current discharge (AA dry battery).

As well, though a commercially available AAA dry battery D is increased in amount of the positive electrode material in one dry battery when compared with the commercially available dry battery C, the discharge duration in the middle rate current discharge (AAA dry battery) of the battery D was almost equal to that of the dry battery C. From this, it was also found that mere increases in amounts of the component materials of the positive electrode and the negative electrode lead to no increase in discharge duration in the middle rate current discharge (AAA dry battery).

The inventors carried out various examination in view of the aforementioned examination results to find that the KOH concentration of the electrolyte is the key to attaining excellent discharge characteristics in the middle rate current discharge, thereby achieving the present invention.

### Embodiment 1

Embodiment 1 of the present invention will be described below in detail with reference to the accompanying drawings. In the drawings, the same reference numerals are assigned to components having substantially the same functions for the sake of simple description. It is noted that the following embodiments are mare examples of the present invention and the present invention is not limited to these examples.

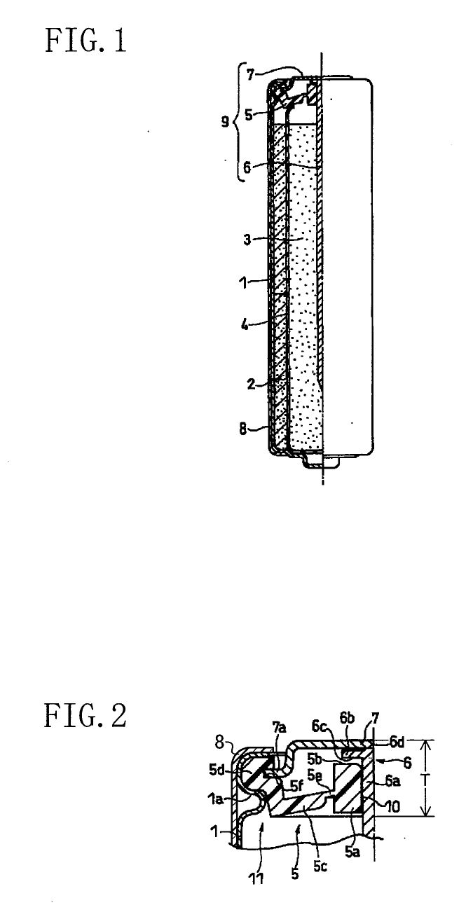

FIG. 1 is a partially exploded sectional view of an AA alkaline dry battery in accordance with the present embodiment. In a battery casing (case) 1 of the AA alkaline dry battery, there are accommodated a positive electrode 2 containing manganese dioxide, a negative electrode 3 containing zinc, and an electrolyte (not shown) containing an aqueous solution of potassium hydroxide.

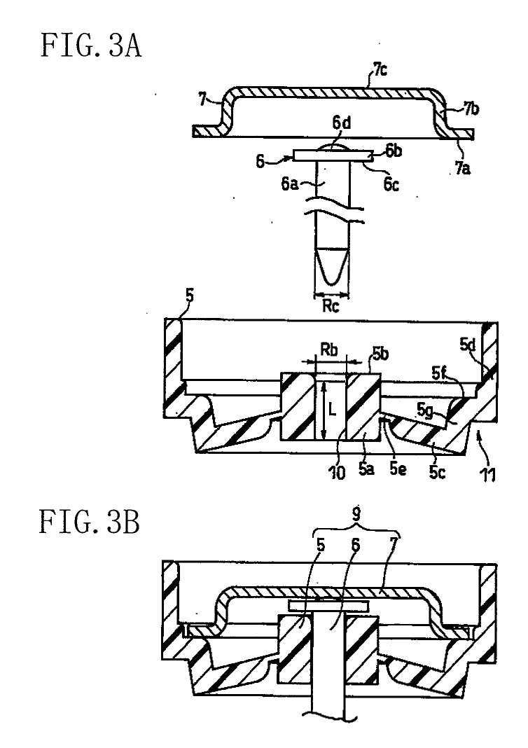

A construction of the AA alkaline dry battery in accordance with the present embodiment will be described further in detail. The hollowed cylindrical positive electrode 2 is in contact with the inner wall of the bottomed cylindrical battery casing 1 serving also as a positive electrode terminal. The negative electrode 3 is arranged in the hollowed part of the positive electrode 2 with a bottomed cylindrical separator 4 interposed. The opening part of the battery casing 1 is sealed by a sealing unit 9. The sealing unit 9 includes a negative electrode terminal plate 7, a negative electrode current collector 6 welded to the negative electrode terminal plate 7, and a resin-made sealing member 5, as shown in FIG. 3. The negative electrode current collector 6 is inserted in the central part of the negative electrode 3. The electrolyte is permeated through the positive electrode 2, the separator 4, and the negative electrode 3 and is therefore not shown.

The battery casing 1 is obtained by press forming, for example, a nickel plated steel plate into a predetermined shape of a predetermined dimension by a known method disclosed in Japanese Unexamined Patent Application Publication 60-180058, Japanese Unexamined Patent Application Publication 11-144690, Japanese Unexamined Patent Application Publication 2007-27046, Japanese Unexamined Patent Application Publication 2007-66762, or the like. The outer diameter of the battery casing 1 in the present embodiment is set at 13.90 mm or larger, wherein the upper limit thereof is 14.10 mm. Of the above listed publications, the latter two publications are preferable because the internal volume of the dry battery can be increased so that the component materials of the positive electrode 2 and the negative electrode 3 can be packed therein much more. When the side face (a cylindrical part) of the battery casing 1 has a thickness of 0.18 mm or smaller, the internal volume of the battery casing 1 increases preferably.

The internal volume of the battery casing 1 means a volume of a space enclosed by the inner face of the bottomed cylindrical battery casing 1, the lower face of the resin-made sealing member 5, and the outer face of the negative electrode current collector 6. Specifically, the internal volume thereof is measured in such a manner that: an AA alkaline dry battery is cut at the vicinity of the positive electrode terminal thereof perpendicularly to the axis of the battery casing 1 (so as not to cut the negative electrode current collector 6); the positive electrode 2, the negative electrode 3, the separator 4, and the electrolyte are removed from the inside thereof; the battery casing 1 cut in two is washed; and water is then filled into the battery casing 1 cut in two.

The outer face of the battery casing 1 is covered with an outer label 8 formed of a plastic film.

The positive electrode 2 contains mainly a positive electrode active material containing manganese dioxide powder and a conductive material, such as graphite powder or the like, wherein the weight of manganese dioxide in one dry battery is 9.30 g or more. Containing much manganese dioxide leads to excellent discharge characteristics not only in the middle rate current discharge but also in the high rate and low rate current discharge (long lifetime). The negative electrode 3 is a substance obtained by mixing a negative electrode active material, such as zinc powder, zinc alloy powder, or the like with a gelled material of which main material is a mixture of electrolyte and a gelling agent, such as sodium polyacrylate or the like. As the negative electrode active material, a zinc alloy powder excellent in anti-corrosion is preferable. Further, none of mercury, cadmium, and lead is preferably added in view of environment. The zinc alloy may contain, for example, at least one of indium, aluminum, and bismuth.

The separator 4 is made of a non-woven fabric obtained by intermingling mainly polyvinyl alcohol fiber and rayon fiber, for example, so as to withstand alkalinity of the electrolyte and so as to allow the electrolyte to pass therethrough.

The electrolyte is an alkaline aqueous solution of which KOH (potassium hydroxide) concentration is 33.5 wt % or lower. The KOH concentration can be obtained by titrating electrolyte present inside a completed dry battery. Japanese Unexamined Patent Application Publication (Translation of PCT Application) No. 2003-536230 discloses an alkaline electric chemical battery in which the concentration of an aqueous solution of KOH before discharge is set at approximately 34 to 37% and the calculation value of the concentration of the aqueous solution of KOH is set at approximately 49.5 to 51.5% in calculation of one-electron discharge of manganese dioxide for the purpose of increasing the lifetime of the dry battery. In the present embodiment, in which the KOH concentration is lower than that of the battery in the publication, the discharge characteristics in the middle rate current discharge can be improved by increasing the amounts of the active materials of the positive electrode 2 and the negative electrode 3. This is the fact that the inventors have found. In other words, the lower the KOH concentration is, the lower the viscosity of the electrolyte is, and accordingly, its mobility in the dry battery might increase, thereby increasing the discharge duration in the middle rate current discharge.

To the electrolyte, ZnO is also added, of which concentration is preferably 3 wt % or lower, more preferably, 1.5 wt % or lower. Preferably, ZnO of 0.2 wt % or higher is contained in the electrolyte.

The sealing part will be described next.

FIG. 2 is an enlarged view of the sealing part (the upper end part) of the dry battery in FIG. 1. After the electricity generating elements, such as the positive electrode 2, the negative electrode 3, and the like are accommodated into the battery casing 1, the vicinity of the upper end part of the battery casing 1 is drawn (crimped) to form a step 1a and is then sealed by the sealing unit 9.

FIG. 3 shows the components of the sealing unit 9 in an enlarged scale, namely, shows in section the negative electrode terminal plate 7 and the sealing member 5. The resin-made sealing member 5 includes: a center cylindrical part 5a through which a through hole 10 for receiving the negative electrode current collector 6 is formed; an outer cylindrical part 11 intervening between a peripheral part 7a of the negative electrode terminal plate 7 and the opening end part of the battery casing 1; and a joint part 5c joining the center cylindrical part 5a and the outer cylindrical part 11 and including a thing part 5e functioning as a safety valve. The outer cylindrical part 11 includes: an annular horizontal part 5f receiving the peripheral part 7a of the negative electrode terminal plate 7; an upper cylindrical part 5d rising upward from the outer peripheral edge of the horizontal part 5f; and a lower cylindrical part 5g extending obliquely downward from the inner peripheral edge of the horizontal part 5f. The opening end part of the battery casing 1 is folded so as to encompass the upper end part of the upper cylindrical part 5d, and the folded part of the battery casing 1 is crimped inward so that the peripheral part 7a of the negative electrode terminal plate 7 is fastened between the folded part and the step 1a of the battery casing 1.

The thus formed resin-made sealing member 5 is prepared by injection molding polyamide, polypropylene, or the like into a predetermined shape of a predetermined dimension, and it is especially preferable to use as a material thereof 6,6-nylon or 6,12-nylon having alkali resistance and heat resistance. The injection molding includes cold runner injection molding and hot runner injection molding. In the case using comparatively expensive 6,12-nylon, hot runner injection molding is suitable because it needs no runner and creates the least material loss.

A lower KOH concentration of the electrolyte increases the amount of generated gas to degrade the leakage characteristics, which can be improved by using a gasket made of a material having a large hydrogen gas transmission rate. The material having a large hydrogen gas transmission rate includes the aforementioned 6,12-nylon.

The negative electrode current collector 6 is prepared by press forming a wire of silver, copper, brass, or the like into a nail shape of a predetermined dimension including a long needle-shaped body part 6a and a collar part 6b. On the opposite side of the collar part 6b to the body part 6a, a protruding parietal part 6d is formed, through which the negative electrode current collector 6 and the negative electrode terminal plate 7 are connected to each other. The surface of the negative electrode current collector 6 is preferably subjected to tin or indium plating for excluding impurities and obtaining a shielding effect in the process. The negative electrode current collector 6 is manufactured by a known method as disclosed in Japanese Unexamined Patent Application Publication 5-283080 or Japanese Unexamined Patent Application Publication 2001-85018, for example.

For press inserting the negative electrode current collector 6 into the through hole 10 in the center cylindrical part 5a of the resin-made sealing member 5, a sealing agent is preferably applied to the body part 6a of the negative electrode current collector 6. As the sealing agent, a resin being excellent in alkali resistance and having high viscosity is preferable, and a polyamide resin or the like having an amine value between 50 and 200 is suitable especially.

The negative electrode terminal plate 7 is a hat-shaped member including a flat ring-shaped peripheral part 7a, a center flat part 7c, and a cylindrical part 7b joining the inner periphery of the peripheral part 7a and the outer periphery of the flat part 7c, as shown in FIG. 3. In the peripheral part 7a of the negative electrode terminal plate 7, a plurality of gas holes (not shown) are formed for allowing pressure upon breakage of the thin part 5e as a safety valve of the resin-made sealing member 5 to escape. The negative electrode terminal plate 7 is manufactured by press forming, for example, a nickel plated steel plate, a tin plated steel plate, or the like into a predetermine shape of a predetermined dimension.

More specifically, each dimension of the parts shown in FIG. 3 are set as follows. Namely, the through hole 10 in the center cylindrical part 5a of the resin-made sealing member 5 has a diameter Rb of 1.05 to 1.45 mm and a length L of 2.2 to 3.8 mm at a part thereof which is in pressure contact with the outer peripheral face of the body part 6a of the negative electrode current collector 6. The body part 6a of the negative electrode current collector 6 has a diameter Rc of 1.08 to 1.57 mm.

When the dry battery of the present embodiment was allowed to discharge in an intermittent mode at 250 mA for one hour per day under an atmosphere at a temperature of 20° C., it was confirmed that the discharge lasted for 9.3 hours or longer. This means remarkably excellent characteristics when compared with the conventional dry batteries indicated in FIG. 7. Thus, when an AA alkaline dry battery is so formed that: the internal volume of the battery casing 1 is set at 6.25 ml or larger; manganese dioxide contained in the positive electrode 2 is set at 9.3 g or more; and the KOH concentration of the electrolyte is set at 33.5 wt % or lower, excellent discharge characteristics in the middle rate current discharge (AA dry battery) are exhibited.

### Working Example 1

First, a zinc alloy powder containing Al of 0.005 wt %, Bi of 0.005 wt %, and In of 0.020 wt % with respect to the weight of zinc was prepared as a zinc alloy powder by a gas atomizing method. The thus prepared zinc alloy powder was classified with the use of a screen for adjusting the grain size thereof in the range between 70 and 300 meshes, wherein the ratio thereof having a grain diameter of 200 meshes (75 μm) or smaller is 30%. The resultant zinc alloy powder was used as a negative electrode active material.

Next, polyacrylic acid and sodium polyacrylate of 2.2 wt % each were added to and were mixed with 100 weight parts of an aqueous solution of potassium hydroxide of 33 wt % (containing ZnO of 1 wt %) for gelling, thereby obtaining a gelled electrolyte. The thus obtained gelled electrolyte was allowed to stand for 24 hours for sufficient maturation.

Thereafter, there was added to and mixed sufficiently with a predetermined amount of the thus obtained gelled electrolyte the prepared zinc alloy powder of 1.92 times at weight ratio, indium hydroxide of 0.025 weight part with respect to the zinc alloy powder of 100 weight parts (0.0164 weight part as metal indium), and the anionic surfactant (alcohol sodium phosphate ester having an average molecular weight of approximately 210) of 0.1 weight part, thereby obtaining a gelled negative electrode.

Subsequently, an electrolytic manganese dioxide (HHTF, a product by TOSOH CORPORATION) and a graphite (SP-20, a product by Nippon Graphite Industries, ltd.) were blended at a weight ratio of 94:6. With the thus mixed powder of 100 weight parts, an electrolyte (an aqueous solution of potassium hydroxide of 33 wt % containing ZnO of 1 wt %) of 1.5 weight parts and polyethylene binder of 0.2 weight part are mixed. Then, the mixture was stirred and mixed evenly by a mixer, and was sized to have a given grain size. The thus obtained grain substance was press formed by a hollowed cylindrical mold to obtain a positive electrode mixture in the form of a pellet.

Next, a sample AA alkaline dry battery was manufactured. As shown in FIG. 1, two pellets of the thus obtained positive electrode mixture (each weight thereof is 5.65 g) were inserted into the battery casing 1, and pressure was applied again thereto in the battery casing 1 to allow them to adhere to the inner face of the battery casing 1. Then, after the separator 4 and a bottom plate for bottom insulation were inserted inside the positive electrode mixture pellets, the electrolyte of 1.83 g prepared as above was injected. Thereafter, the gelled negative electrode 3 was filled inside the separator 4. The resin-made sealing member 5, the negative electrode terminal plate 7, and the negative electrode current collector 6 were inserted into the negative electrode 3, and the open end of the battery casing 1 was crimped to the peripheral part of the negative electrode terminal plate 7 with the edge of the sealing member 5 interposed, thereby sealing the opening part of the battery casing 1. The outer surface of the battery casing 1 was covered with an outer label 8 to thus complete an AA alkaline dry battery.

As a material of the resin-made sealing member, 6,12-nylon was used. A tin-plated copper wire was used as the negative electrode current collector. An alkaline dry battery separator by KURARAY CO., LTD. (a composite fiber made of vinylon and tencel) was used as the separator.

### Working Example 2

An AA alkaline dry battery of Working Example 2 has the same construction and is made of the same materials at the same blend ratios as those of Working Example 1 except that the concentration of ZnO contained in the aqueous solution of potassium hydroxide of 33 wt % is 2 wt %.

AA dry battery evaluating methods will be described next. The numerical values in FIG. 7 were obtained also by the following evaluating methods.

(1) Internal Volume of Battery Casing

A dry battery from which the outer label has been removed was cut into two at a part approximately 1 cm apart from the protruding part as the negative electrode terminal perpendicularly to the axis of the cylindrical battery casing. The positive electrode, the negative electrode, the separator, electrolyte, and the like were taken out from the battery casing with the sealing unit left therein, and the inside of the battery casing was washed sufficiently and was dried.

The weight of the thus cut two parts of the battery casing after being dried was measured. Then, water was filled into the two parts of the battery casing up to the cut planes thereof with the cut parts thereof facing upward, and the weight of the battery casing was measured again. The weight of the water in the battery casing was obtained from the thus measured weight, and the internal volume of the battery casing was calculated from the thus obtained weight of the water. The internal volumes of five dry batteries of each type were measured as above, and the averages of the measurement values were used as the internal volumes of the dry batteries of the types.

(2) MnO₂ Amount, KOH Concentration, and ZnO Concentration

After the sealing part of a dry battery from which the outer label has been removed was cut open, the negative electrode gel and the electrolyte adhering to the sealing member were washed out into a beaker with the use of ion-exchanged water. Then, all the negative electrode gel in the dry battery was put into the beaker, the separator was taken out from the battery, and then, the negative electrode gel and the electrolyte adhering thereto were washed out into the beaker with the use of the ion-exchanged water. The sealing member and the separator were dried, and their weights were measured.

The negative electrode gel collected in the beaker was washed with water and decantationed about ten times to separate KOH (potassium hydroxide) into supernatant liquid from almost all the negative electrode gel. The thus obtained supernatant liquid was subjected to neutralization titration by hydrochloric acid of 1N to obtain the amount (a1) of KOH in the supernatant liquid. The residual negative electrode gel (zinc powder and gelling agent) was washed and dried, and then, the weight thereof was measured.

After hydrochloric acid was added to the supernatant liquid after neutralization titration to dissolve the suspended matter, a buffering solution of acetic acid/ammonium acetate and an XO indicator were added. Then, titration was performed with the use of 1/100 M-EDTA solution to obtain the amount (b1) of dissolved ZnO.

The positive electrode mixture was taken out from the battery casing and was dried, and the weight thereof was measured. Then, the positive electrode mixture was crushed, a concentrated hydrochloric acid was added thereto, MnO₂ was dissolved by heating, and then, the resultant substance was filtered to be separated from residue. The residue not dissolved in hydrochloric acid (a graphite conductive material and a binder component in the positive electrode mixture) was dried, and its weight was measured. A given amount of a solution to which MnO₂ is dissolved was fractionated, (1+1)NH₄OH was dripped thereto so that the solution becomes pH 3, and then, hydrogen peroxide was added and stirred. Concentrated NH₄OH was further added and stirred to precipitate MnO₂. The thus precipitated substance was filtered, was washed with water, and was then dissolved completely into hydroxylamine hydrochloride of 10 W/V % and (1+1) hydrochloric acid. Then, triethanolamine, an ammonium chloride/ammonia-based buffering solution, and a TPC indicator were added thereto, and then, the resultant substance was titrated with the use of 1/20 M-EDTA solution to obtain the amount of MnO₂. From the thus obtained amount of MnO₂, the amount of MnO₂ present in one dry battery was calculated. The amount of electrolytic manganese dioxide (EMD) used in the dry battery was calculated from the thus obtained amount of MnO₂ (the content of pure MnO₂ in EDM was approximately 93%).

Subsequently, a given amount of the solution to which MnO₂ is dissolved was fractionated again, and was analyzed by ICP (inductively coupled plasma) spectrometry (standard addition method) to quantify the amount of Zn, and then, the amount (b2) of ZnO contained in the positive electrode mixture was calculated. The same solution was also analyzed by atomic absorption analysis (standard addition method) to quantify the amount of potassium, and then, the amount (a2) of KOH contained in the positive electrode mixture was calculated.

According to the above measurements, the weight (c) of the electrolyte in the dry battery was obtained by subtracting from the total weight of the battery the total weight of the components (the total weight of the outer label, the battery casing, the sealing member, the separator, the zinc powder and the gelling agent, the EMD, and the residue not dissoluble in hydrochloric acid) other than the electrolyte. The KOH concentration (wt %) (=(a1+a2)/c) of the electrolyte and the ZnO concentration (wt %) (b1+b2)/c) thereof were obtained from the total amount (a1+a2) of KOH and the total amount (b1+b2) of ZnO in the dry battery, respectively.

(3) Thickness of Sealing Part

The battery casing of a dry battery from which the outer label has been removed was cut at the central part thereof perpendicularly to the axis of the cylindrical battery casing. All of the positive electrode, the negative electrode, the separator, and the electrolyte were taken out from a cut part of the battery casing in which the negative electrode terminal remains, and the battery casing was washed with the sealing unit left inside and was dried. The washed and dried battery casing was immersed into epoxy resin for thermal hardening. The thus thermally hardened substance was cut along a section including the axis of the cylindrical battery casing, the thus cut section was polished and was observed under an optical microscope for measuring the thickness of the sealing part. As shown in FIG. 2, the thickness T of the sealing part is a distance between the outer face of the flat part 7c of the negative electrode terminal plate 7 and the lower end of the lower cylindrical part 5g of the resin-made sealing member 5.

(4) Discharge Characteristics in Middle Rate Current Discharge (AA Dry Battery)

The dry battery was connected to a test load and was allowed to discharge at 250 mA for one hour per day in a thermostatic bath at 20° C. The battery voltage during the discharge was recorded, and the discharge duration until the battery voltage became equal to or lower than 0.9 V was obtained.

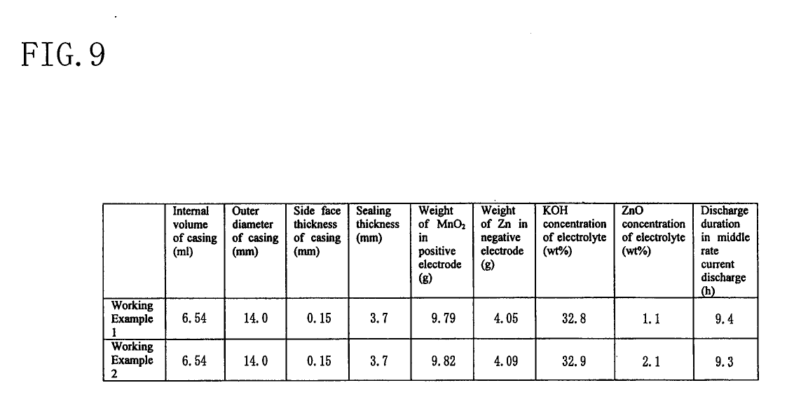

The evaluation results of Working Examples 1 and 2 are indicated in FIG. 9.

As indicated in FIG. 9, the AA alkaline dry batteries of Working Examples 1 and 2 have 9.3 or longer discharge duration as their discharge characteristics in the middle rate current discharge (AA dry battery), which means remarkably excellent in discharge characteristics in the middle rate current discharge (AA dry battery) when compared with the commercially available dry batteries A, B indicated in FIG. 7.

### Embodiment 2

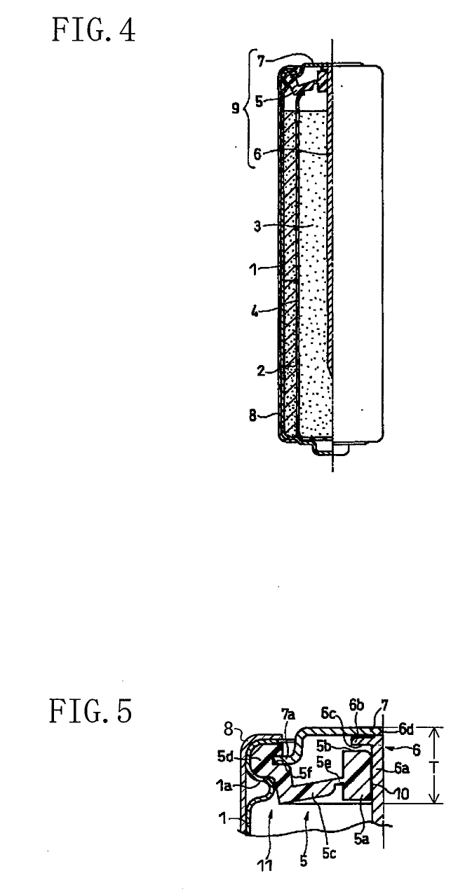

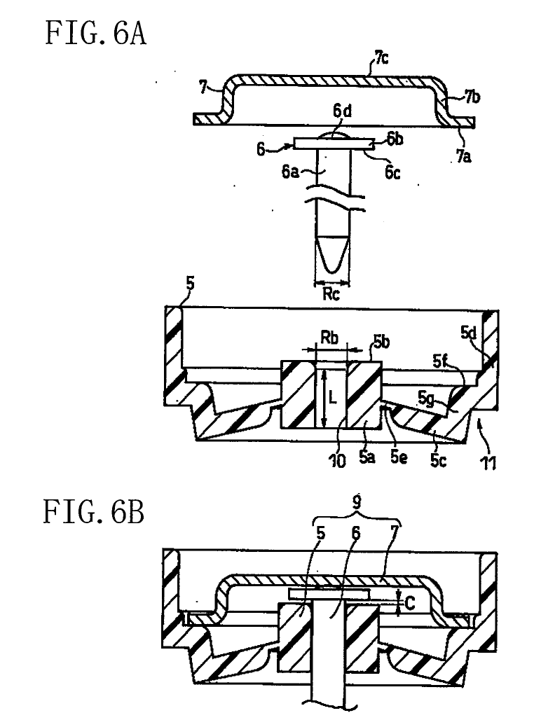

FIG. 4 is a partially exploded sectional view of an AAA alkaline dry battery in accordance with Embodiment 2. FIG. 5 shows an enlarged section of its sealing part, and FIG. 6 shows a construction of its sealing unit. In a battery casing (case) 1 of this AAA alkaline dry battery, there are accommodated a positive electrode 2 containing manganese dioxide, a negative electrode 3 containing zinc, and electrolyte (not shown) containing an aqueous solution of potassium hydroxide. The internal construction and shape thereof are the same as those of the AA alkaline dry battery in accordance with Embodiment 1 while each dimension of the components and the amounts of the component materials are different from those in Embodiment 1. Therefore, only difference from Embodiment 1 will be described for omitting description of the same details.

In the present embodiment, the thickness of the side face (a cylindrical part) of the battery casing 1 is preferably 0.18 mm or smaller for increasing the internal volume of the battery casing 1.

The positive electrode 2 contains mainly a positive electrode active material containing manganese dioxide powder and a conductive material, such as graphite powder, and manganese dioxide in one dry battery is 4.05 g or more. Containing much manganese dioxide results in excellent discharge characteristics not only in middle rate current discharge but also in high rate and low rate current discharge (long lifetime).

The electrolyte is an alkaline aqueous solution of which KOH concentration is in the range between 26.0 and 34.0 wt %, both inclusive. The KOH concentration can be obtained by analyzing electrolyte present in a completed dry battery.

To the electrolyte, ZnO is also added, of which concentration is preferably 3 wt % or lower, more preferably, below 2.0 wt %. This setting can retard inactivation of the positive electrode active material in the terminal discharge stage (generation of hydrohetaerolite) and passivation of zinc in the negative electrode. Preferably, ZnO of 0.2 wt % or higher is contained in the electrolyte.

Preferably, the amount of zinc in one dry battery is 1.70 g or more to increase the discharge capacity in the middle rate current discharge. Whereby, the capacity balance between the positive and negative electrodes on dry battery design can be readily achieve against a positive electrode containing 4.05 g or more manganese dioxide.

Further, the liquid amount in one battery is set preferably at 1.77 g or more to increase the discharge capacity in the middle rate current discharge. This suppresses liquid exhaustion of the separator accompanied by water consumption at discharge.

The sealing part will be described next. Each dimension of the parts shown in FIG. 6 are set as follows. Namely, the through hole 10 in the center cylindrical part 5a of the resin-made sealing member 5 has a diameter Rb of 1.05 to 1.45 mm and a length L of 2.2 to 6.0 mm at a part thereof which is in pressure contact with the outer peripheral face of the body part 6a of the negative electrode current collector 6. The body part 6a of the negative electrode current collector 6 has a diameter Rc of 1.08 to 1.57 mm.

When the dry battery of the present embodiment was allowed to discharge in an intermittent mode at 100 mA for one hour per day under an atmosphere at a temperature of 20° C., it was confirmed that the discharge thereof lasted for 11 hours or longer. This means remarkably excellent characteristics when compared with the conventional dry batteries indicated in FIG. 8. Thus, when an AAA alkaline dry battery is so arranged that: the internal volume of the battery casing 1 is set at 2.86 ml or larger; manganese dioxide contained in the positive electrode 2 is set at 4.05 g or more; and the KOH concentration of the electrolyte is set in the range between 26.0 and 34.0 wt %, both inclusive, excellent discharge characteristics in the middle rate current discharge (AAA dry battery) are exhibited.

### Working Example 3

The same gelled negative electrode and positive electrode as those in Working Example 1 were prepared.

Subsequently, a sample AAA alkaline dry battery was prepared. Two pellets of the positive electrode mixture obtained as above (each weight thereof is 2.46 g) were inserted into the battery casing 1, and pressure was applied again thereto in the battery casing 1 to allow them to adhere to the inner face of the battery casing 1, as shown in FIG. 4. Then, after the separator 4 and a bottom plate for bottom insulation were inserted inside the positive electrode mixture pellets, the electrolyte prepared as above of 0.84 g was injected. Thereafter, the gelled negative electrode 3 was filled inside the separator 4. The resin-made sealing member 5, the negative electrode terminal plate 7, and the negative electrode current collector 6 were inserted into the negative electrode 3, and the open end of the battery casing 1 was crimped to the peripheral part of the negative electrode terminal plate 7 with the edge of the sealing member 5 interposed, thereby sealing the opening part of the battery casing 1. The outer surface of the battery casing 1 was covered with an outer label 8 to thus complete an AAA alkaline dry battery.

As a material of the resin-made sealing member 5, 6,12-nylon was used. A tin-plated copper wire was used as the negative electrode current collector 6. An alkaline dry battery separator by KURARAY CO., LTD. (a composite fiber made of vinylon and tencel) was used as the separator 4.

AAA dry battery evaluating methods will be described next. The numerical values in FIG. 8 were obtained also by the following evaluating methods.

(1) Internal Volume of Battery Casing

The same evaluating method as in Embodiment 1 was employed.

(2) MnO₂ Amount, KOH Concentration, and ZnO Concentration

The same evaluating method as in Embodiment 1 was employed.

(3) Discharge Characteristics in Middle Rate Current Discharge (AAA Dry Battery)

The dry battery was connected to a test load and was allowed to discharge at 100 mA for one hour per day in a thermostatic bath at 20° C. The battery voltage during the discharge was recorded, and the discharge duration until the battery voltage became equal to or lower than 0.9 V was obtained.

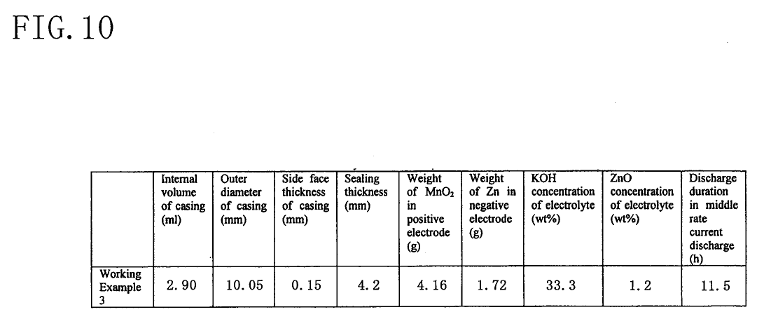

The evaluation results of Working Example 3 are indicated in FIG. 10.

As indicated in FIG. 10, the AA alkaline dry battery of Working Example 3 has 11 or longer discharge duration as the discharge characteristics in the middle rate current discharge (AAA dry battery), which means remarkably excellent in discharge characteristics in the middle rate current discharge (AAA dry battery) when compared with the commercially available dry batteries C, D indicated in FIG. 8.

As described above, the AA alkaline dry battery and the AAA alkaline dry battery in accordance with the present invention are excellent in the discharge characteristics in the middle rate current discharge and are therefore useful for use in portable AV tools, electronic game machines, and the like.

In the AA alkaline dry battery and the AAA alkaline dry battery in accordance with the present invention, a synergetic effect is obtained by packing much amount of the positive electrode active material by increasing the internal volume of the battery casing and reducing the KOH concentration of the electrolyte, thereby remarkably improving the discharge characteristics in the middle rate current discharge.

What is claimed is:

1. An AA alkaline dry battery comprising:
a bottomed cylindrical casing accommodating a positive electrode containing manganese dioxide, a negative electrode containing zinc, and electrolyte containing an aqueous solution of potassium hydroxide;
a sealing member sealing the casing; and
a negative electrode current collector extending from the sealing member into the negative electrode,
wherein an internal volume of the casing which is defined by the casing, the sealing member, and the negative electrode current collector is 6.25 ml or larger,
the manganese dioxide contained in the positive electrode is 9.30 g or more,
a concentration of the potassium hydroxide of the electrolyte is 33.5 wt % or lower, and
discharge duration until a battery voltage becomes 0.9 V is 9.3 hours or longer where discharge at 250 mA is performed at 25° C. for one hour per day.

2. The AA alkaline dry battery of claim 1,
wherein the casing has an outer diameter of 13.90 mm or larger.

3. The AA alkaline dry battery of claim 1,
wherein the casing has a side face of which thickness is 0.20 mm or smaller.

4. The AA alkaline dry battery of claim 1,
wherein a sealing thickness, which is a distance between a top face of the negative electrode terminal plate and a lower end of the sealing member is 4.0 mm or smaller.

5. The AA alkaline dry battery of claim 1,
wherein the electrolyte contains ZnO of which concentration is 1.5 weight % or lower.

6. An AAA alkaline dry battery comprising:
a bottomed cylindrical casing accommodating a positive electrode containing manganese dioxide, a negative electrode containing zinc, and electrolyte containing an aqueous solution of potassium hydroxide;
a sealing member sealing the casing; and
a negative electrode current collector extending from the sealing member into the negative electrode,
wherein an internal volume of the casing which is defined by the casing, the sealing member, and the negative electrode current collector is 2.86 ml or larger,
the manganese dioxide contained in the positive electrode is 4.05 g or more,
a concentration of the potassium hydroxide of the electrolyte is in a range between 26.0 and 34.0 wt %, both inclusive, and
discharge duration until a battery voltage becomes 0.9 V is 11 hours or longer where discharge at 100 mA is performed at 25° C. for one hour per day.

7. The AAA alkaline dry battery of claim 6,
wherein the casing has a side face of which thickness is 0.20 mm or smaller.

8. The AAA alkaline dry battery of claim 6,
wherein the electrolyte contains ZnO of which concentration is below 2.0 weight %.
